(19) United States
(12) Patent Application Publication
(10) Pub. No.: US 2014/0164279 A1
(43) Pub. Date: Jun. 12, 2014

(54) CONTAINER INFORMATION CONTROL SYSTEM AND CONTAINER INFORMATION CONTROL METHOD

(71) Applicant: Electronics and Telecommunications Reasearch Institute, Daejeon (KR)

(72) Inventor: Hyoung Oh BAE, Daejeon (KR)

(73) Assignee: Electronics and Telecommunications Reasearch Institute, Daejeon (KR)

(21) Appl. No.: 13/956,949

(22) Filed: Aug. 1, 2013

(30) Foreign Application Priority Data
Dec. 10, 2012 (KR) 10-2012-0142541

(51) Int. Cl. G06Q 10/08

(52) U.S. Cl. CPC G06Q 10/0833
USPC 705/333

(57) ABSTRACT

Disclosed are a container information control system and a container information control method capable of simply and accurately collecting and controlling container information by using an optical or laser transceiver in which multiple paths or interference signals are not generated. A system for controlling information on containers according to an exemplary embodiment of the present invention includes: one or more transceivers connected to internal sensors of the containers, respectively, in which information on the respective containers is stored; and a wireless access point positioned at an uppermost container, and configured to receive the container information from the transceivers.

### CROSS-REFERENCE TO RELATED APPLICATIONS

This application claims priority to and the benefit of Korean Patent Application No. 10-2012-0142541 filed in the Korean Intellectual Property Office on Dec. 10, 2012, the entire contents of which are incorporated herein by reference.

### TECHNICAL FIELD

The present invention relates to a container information control system and a container information control method. More particularly, the present invention relates to a container information control system and a container information control method of collecting and controlling information inside of a container by using an optical or laser transceiver in a poor radio wave environment, such as a lower part of a container ship.

### BACKGROUND ART

An existing method of recognizing container information in a container ship which is a ship loading and carrying a container includes a method of recognizing only position information of a container in an outdoor environment, such as an open-storage yard, in which wireless communication is available, or a method of recognizing information inside of the container through local area wireless communication by directly attaching a wireless device to external sides of containers loaded inside a container ship.

The existing method has a problem in that a poor radio wave environment due to multiple paths is formed in a closed space inside the container ship in which containers formed of metal members are loaded, and actual wireless communication is extremely difficult in this type of environment due to interference signals caused by a plurality of wireless devices.

When a communication method strongly resistant to the interference signal is used in order to avoid the interference signals by the plurality of wireless devices, there occurs a problem in that a wireless device system is complex and cost is increased. Although it is assumed that different frequency bands are allocated to the plurality of wireless devices, there is a problem of causing inefficient use of a frequency resource.

### SUMMARY OF THE INVENTION

The present invention has been made in an effort to provide a container information control system and a container information control method capable of simply and accurately collecting container information and controlling container information by using an optical or laser transceiver in which multiple paths or interference signals are not generated.

An exemplary embodiment of the present invention provides a system for controlling information on containers, including: one or more transceivers connected to internal sensors of respective containers in which information on the respective containers is stored; and a wireless access point positioned at an uppermost container, and configured to receive the container information from the transceivers.

The transceiver may be any one of an optical transceiver or a laser transceiver.

The container information transmitted from the transceivers to the wireless access point may be contained in a message structure, which is divided into a start flag section of a specific pattern notifying a start of the information, a container ID section using coordinates of a loading space of the container, an information section containing information desired to be transmitted by each container, and a stop flag section notifying an end of the information, to be transmitted.

Each of the transceivers may transmit information on a container connected to each transceiver to the wireless access point for each predetermined interval.

The system may further include a wireless terminal configured to receive the container information through the wireless access point, and transmit at least one signal among a signal for changing the container information, a signal for re-requesting the container information, and a signal for controlling the container through the wireless access point.

The transceivers may transmit the container information to the wireless access point by using any one of self transmission or upstream transmission.

A signal transmitted from the wireless terminal to the wireless access point may be transmitted to any one transceiver among the transceivers through downstream transmission.

Another exemplary embodiment of the present invention provides a method of transmitting information on containers to a wireless terminal, including step (a) of transmitting the container information to a wireless access point positioned at an uppermost container by using at least one of self transmission and upstream transmission by one or more transceivers connected to internal sensors of the containers, respectively, in which information on the respective containers is stored.

The transceiver may be a transceiver using at least one of light and laser, and the self transmission or the upstream transmission may be performed by using at least one of the light and the laser.

The container information transmitted from the transceivers to the wireless access point may be contained in a message structure, which is divided into a start flag section of a specific pattern notifying a start of the information, a container ID section using coordinates of a loading space of the container, an information section containing information desired to be transmitted by each container, and a stop flag section notifying an end of the information, to be transmitted.

The self transmission may be performed for each predetermined interval.

The method may further include step (b) of transmitting at least one signal among a signal for changing the container information, a signal for re-requesting the container information, and a signal for controlling the container through the wireless access point, by the wireless terminal.

In step (b), a signal transmitted from the wireless terminal to the wireless access point may be transmitted to any one transceiver among the transceivers through downstream transmission.

According to the exemplary embodiments of the present invention, it is possible to collect and control container information even in a poor radio wave environment.

According to the exemplary embodiments of the present invention, it is possible to collect and control container information at low cost.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a container information control system according to an exemplary embodiment of the present invention.

FIG. 2 is a diagram illustrating an example of a data structure of information transceived in transceivers of the container information control system according to the exemplary embodiment of the present invention.

FIG. 3 is a flowchart of a container information control method according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numerals refer to the same or equivalent parts of the present invention throughout the several figures of the drawing.

### DETAILED DESCRIPTION

Hereinafter, exemplary embodiments of the present invention will be described in detail with reference to the drawings. Substantially the same constituent elements are indicated by the same reference numerals in the following description and the accompanying drawings, so that a repeated description will be omitted. In the description of the present invention, a detailed explanation of known related functions and constitutions may be omitted when it is determined to unnecessarily make the subject matter of the present invention obscure.

The present invention relates to a method of collecting and controlling information inside of a container in a poor radio wave environment, such as a lower part of a container ship. Particularly, the present invention transceiver information between containers by using an optical transceiver or a laser transceiver, and the information is finally transmitted to a terminal such as a smart phone or an information collecting station, capable of performing wireless communication through a wireless access point mounted to a container at an uppermost portion at which a radio wave environment is secured. Through this, the terminal such as a smart phone, or the information collecting station may identify the container information in real time and control the container information.

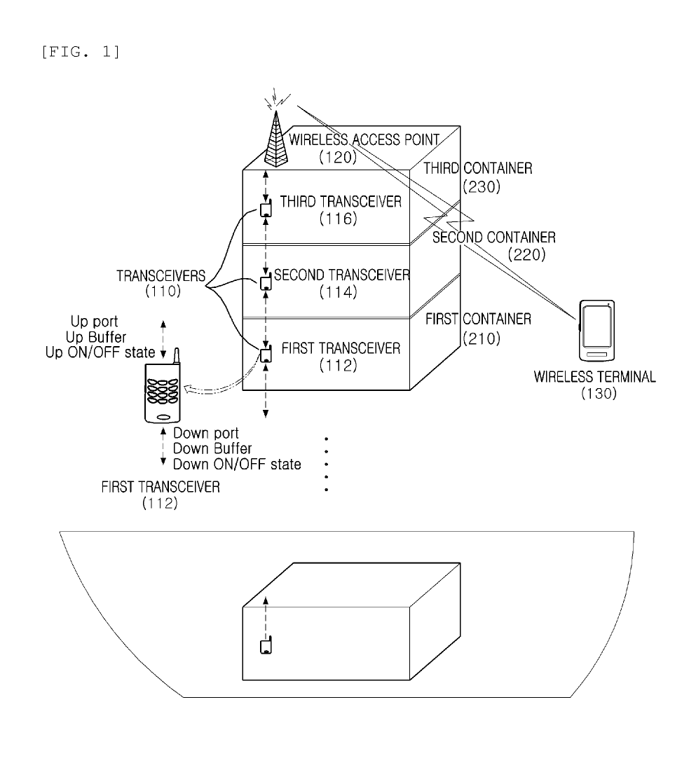

FIG. 1 is a diagram illustrating a container information control system according to an exemplary embodiment of the present invention.

Referring to FIG. 1, a container information control system 100 according to an exemplary embodiment of the present invention includes transceivers 110 and a wireless access point 120, and may further include a wireless terminal 130.

The transceivers 110 are connected to internal sensors of the containers, respectively, in which information on the respective containers is stored. That is, one transceiver may be connected to one container, and thus the transceivers 110 mean one or more transceivers.

The transceiver may be an optical transceiver or a laser transceiver capable of transmitting and receiving information with light or laser.

The optical transceiver or the laser transceiver has an advantage in that multiple paths or an interference signal is not generated, and is efficient at a closed space in which containers formed of metal members are loaded.

The transceiver may transmit the container information to the wireless terminal 130 through the wireless access point 120 by using light or laser.

The container information may be information relating to a position of the container, a destination of the container, contents loaded in the container, or the like. The wireless terminal 130 may be a smart phone, a tablet PC, or a notebook computer, which is a portable device with which wireless communication is available, and includes an information collecting station installed in the container ship.

The wireless terminal 130 may transmit information for correcting or controlling each container information by using the transceiver through the wireless access point 120.

Particularly, a process of transceiving the container information, and receiving correction information or control information from the wireless terminal 130 by the transceiver will be described.

Transmission of the information in a direction of the wireless access point 120 at an uppermost end of the transceiver is referred to as upstream transmission, and contrary to this, transmission of the information in a direction of the transceiver from the direction of the wireless access point 120 is referred to as downstream transmission.

An example will be provided based on a second transceiver 114 which is a specific transceiver among the transceivers 110. In a case where a first transceiver 112 desires to transmit information to the wireless access point 120, the information transmitted by the first transceiver 112 is transmitted through the second transceiver 114 and a third transceiver 116. This case is referred to as upstream transmission. On the contrary, when a smart phone transmits control information to correct information on a first container 210 connected with the first transceiver 112 through the wireless access point 120, the control information through the wireless access point 120 is transmitted to the first transceiver 112 through the third transceiver 116 and the second transceiver 114. This case is referred to as downstream transmission.

A case where the second transceiver 114 transmits information on a second container 220 to the wireless terminal 130 through the wireless access point 120 is referred to as self transmission which is not the upstream transmission or the downstream transmission. Each of the transceivers 110 may transmit the information on the container connected to each transceiver to the wireless terminal 130 through the wireless access point 120 for each predetermined interval. The predetermined interval may be set and changed by a user.

A method of avoiding transceive collision between the upstream transmission, the downstream transmission, and the self transmission performed by the transceivers 110 is required, and an information transmission message structure and an information transmission order for avoiding transceive collision in the container information control system 100 according to the present invention will be described.

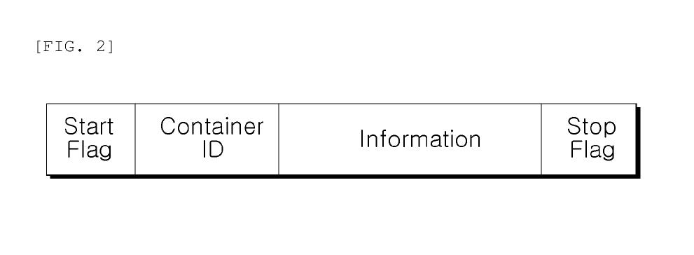

FIG. 2 is a diagram illustrating an example of a data structure of information transceived in the transceivers of the container information control system according to the exemplary embodiment of the present invention.

Referring to FIG. 2, a data structure containing information transceived by the transceivers 110 may be divided into a start flat section, a container ID section, an information section, and a stop flag section.

The start flag section is a section notifying a start of the information. The start flag section may notify the start of the information by using a specific pattern predetermined between the transceivers 110 transceiving the container information, the wireless access point 120, and the wireless terminal 130.

The container ID section is a section containing container identification information by using X, Y, and Z coordinates of a container loading space of the container ship. That is, the information of the container ID section notifies a container to which information of corresponding data corresponds.

The information section is a section containing information on the container. Since information desired to be transmitted by each container may be different, the information section may be divided into an information ID section and an info section. The information ID section may contain information about an identification code determined by classifying several types of container information in advance. The identification code determined by classifying several types of container information in advance may be determined by classifying the container information according to a necessity of the user. The information desired to be transmitted by each container is contained in the info section. That is, the info section may contain only information desired to be transmitted by each container or information requested by the wireless terminal 130, not every element of the container information of each container.

The information section is divided into the information ID section and the info section, and contains only information desired to be transmitted or information requested by the wireless terminal 130 to be transmitted, thereby minimizing a length of transmission data.

The stop flag section is a section notifying the end of the information. The stop flag section may notify the end of the information by using a specific pattern predetermined between the transceivers 110 transceiving the container information, the wireless access point 120, and the wireless terminal 130.

A method of avoiding collision between the upstream transmission, the downstream transmission, and the self transmission according to the present invention will be described. Before the description, several terms will be defined. A port used for upstream transmission by the transceivers 110 is referred to as an up port, and a port used for downstream transmission by the transceivers 110 is referred to as a down port. That is, each of the transceivers 110 may have an up port and a down port.

Each of the transceivers 110 may have an up buffer and a down buffer in order to avoid collision between the upstream transmission, the downstream transmission, and the self transmission, and an up down on/off state may be changed. The up buffer is a buffer for temporarily storing upstream transmitted information, and the down buffer is a buffer for temporarily storing downstream transmitted information.

After power is applied to the transceivers 110, the up down on/off state is activated. Initial states of the transceivers 110 after the power application are an up down off state, and in a case where a start flag is detected in the up port or the down port, the up down on/off state may be changed.

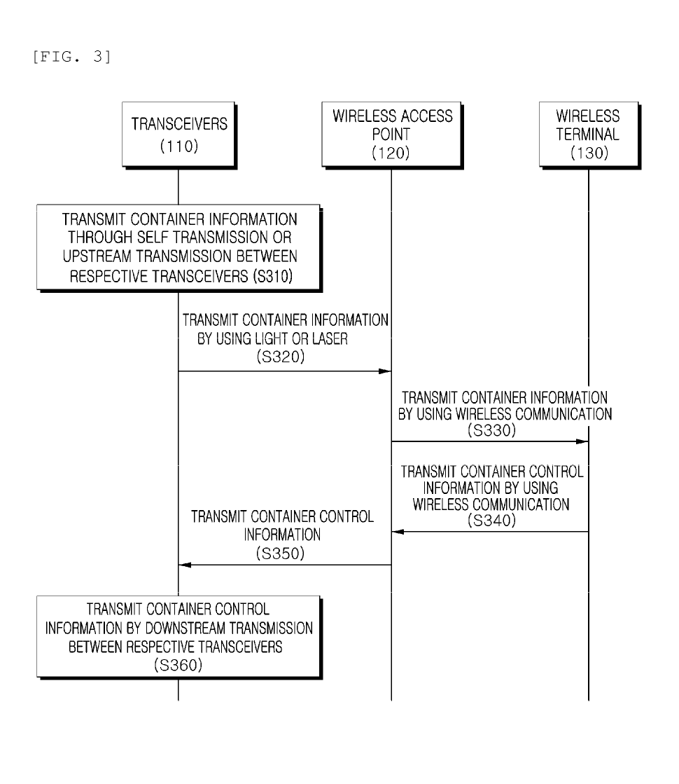

This will be described in detail with reference to FIG. 3. The down port of each of the transceivers 110 continuously searches for the start flag transmitted from the transceiver positioned under each transceiver for the upstream transmission after the power application. Simultaneously, the up port of each of the transceivers 110 continuously searches for the start flag transmitted from the transceiver positioned above each transceiver for the downstream transmission.

When the start flag is detected in the down port, the state of the up port is identified, and when the up port is in the on state, the information from the container ID to the stop flag is stored in the up buffer, and when the up port is in the off state, the container information is transmitted through the up port.

The downstream transmission may be linked with the detection of the start flag and a self transmission interval in the up port to be operated. When the start flag is detected in the up port not at the self transmission interval, each of the transceivers 110 identifies whether the container ID contained in the downstream transmitted information is a container ID of a container connected to the transceiver. When the container ID of the container connected to the transceiver is the same as the container ID contained in the downstream transmitted information, the information or a command stored in the corresponding information section is performed. On the contrary, when the container ID of the container connected to the transceiver is different from the container ID contained in the downstream transmitted information, the state of the down port is identified. When the state of the down port is the on state, information from the container ID to the stop flag is stored in the down buffer, and when the state of the down port is the off state, a container information correction command or a container control command is transmitted through the down port.

At the self transmission interval, the transceiver identifies the state of the up port. When the state of the up port is the on state, the transceiver stores information desired to be transmitted in the up buffer, and when the state of the up port is the off state, the transceiver transmits its own information through the up port. When the start flag is not detected in the up port or the down port, the information stored in the up buffer or the down buffer is transmitted.

In order to help understanding a flow of information transmission for avoiding the collision between the upstream transmission, the downstream transmission, and the self transmission, the description will be provided based on the second transceiver 114 of FIG. 1.

Whether there is the upstream transmission in which the second transceiver 114 receives information from the transceiver positioned under the second transceiver 114 and transmits the received information to the third transceiver 116 may be determined by detecting the start flag in the down port of the second transceiver 114. Simultaneously, whether there is the downstream transmission in which the second transceiver 114 receives information from the transceiver positioned above the second transceiver 114 and transmits the received information to the first transceiver 112 may be determined by detecting the start flag in the up port of the second transceiver 114.

When the start flag is detected in the down port of the second transceiver 114, that is, there is the upstream transmission, the state of the up port of the second transceiver 114 is identified. When the state of the up port of the second transceiver 14 is the on state and is currently operated, the downstream transmission is currently performed, so that the information desired to be upstream transmitted may be stored in the up buffer, and the information stored in the up buffer may be transmitted later when the upstream transmission is available.

On the contrary, when the state of the up port of the second transceiver 114 is the off state and there is no downstream transmission, the information desired to be upstream transmitted is transmitted to the third transceiver 116 through the up port. The third transceiver 116 positioned at the uppermost container transmits the received information to the wireless access point 120, and the wireless access point 120 may transmit the received information to the wireless terminal 130.

In a case where an interval at which the second transceiver 114 transmits the information on the second container 220 arrives, the second transceiver 114 identifies the state of the up port. When the state of the up port is the on state, that is, the up port is currently operated, the second transceiver 114 temporarily stores the information on the second container 220 to be transmitted to the wireless terminal 130 in the up buffer, and when the state of the up port is the off state, the second transceiver 114 transmits the temporarily stored information. When the second transceiver 114 identifies the state of the up port and then the state of the up port is the off state, the second transceiver 114 may transmit the information on the second container 220 to the third transceiver 116 through the up port. The third transceiver 116 transmits the information on the second container 220 to the wireless access point 120 through the upstream transmission, and the wireless access point 120 may transmit the information on the second container 220 to the wireless terminal 130 through wireless communication.

In a case of the downstream transmission in which the second transceiver 114 receives the information from the transceiver positioned above the second transceiver 114, when the start flag is detected in the up port, the second transceiver 114 identifies the container ID information contained in a corresponding data structure, and identifies whether the container ID information is an identification code representing the second container 220. When the container ID contained in the information transmitted from the third transceiver 116 does represent the second container 220, the second transceiver 114 identifies the state of the down port. When the identified state of the down port is the on state, the second transceiver 114 may temporarily store the information to be downstream transmitted to the down buffer, and then transmit the temporarily stored information when the state of the down port is the off state. On the contrary, when the identified state of the down port is the off state, the second transceiver 114 may transmit the information transmitted from the third transceiver 116 to the first transceiver 112 through the down port of the second transceiver 114.

When the container ID contained in the information received from the third transceiver 116 represents the second container 220, the second transceiver 114 may perform the information contained in the received information. The information contained in the received information may be information for changing the information on the second container 220, an information request, such as the information on the second container 220 or information for changing an internal temperature of the second container 220, and information containing a stored information change or command.

The example based on the second transceiver 114 is described in order to help understanding the upstream transmission, the downstream transmission, and the self transmission of the present invention, but all of the respective transceivers including the transceivers 110 perform the same transmission as that of the second transceiver 114, so that the respective transceivers finally transceive the information with the transceivers 110, the wireless access point 120, and the wireless terminal 130.

In the container information control system 100 according to the present invention, when the transceiver connected with each container transmits the information to the wireless access point 120 through the self transmission and the upstream transmission, the transceiver may transmit the received information to the wireless terminal 130 to the wireless access point 120 through wireless communication. A user of the wireless terminal 130 may accurately and easily recognize the container information through the aforementioned transmission of the container information, and when a change signal of the information, a re-request signal of the information, or a control command signal of the container is transmitted to the wireless access point 120, the information transmitted to the wireless access point 120 may be transmitted to a corresponding container through the downstream transmission.

FIG. 3 is a flowchart of a container information control method according to an exemplary embodiment of the present invention.

A container information control method according to an exemplary embodiment of the present invention will be described with reference to FIG. 3. Each of the transceivers 110 performs self transmission or upstream transmission in order to transmit container information to the wireless access point 120 (step S310).

A transceiver connected to the uppermost container transmits the upstream transmitted container information or its own container information to the wireless access point 120 by using light or laser (step S320).

The wireless access point 120 transmits the container information received from the transceivers 110 to the wireless terminal 130 by using wireless communication (step S330).

The wireless terminal 130 may transmit container control information to the wireless access point 120 by using wireless communication (step S340).

The container control information means information for controlling container related information or controlling the container itself, such as a change in the container information, a re-request for the container information, or a change in an internal temperature of the container.

The wireless access point 120 transmits the container control information received from the wireless terminal 130 to the transceiver connected to the uppermost container (step S350).

The transceiver connected to the uppermost container receives the container control information and downstream transmits the received container control information (step S360). The downstream transmission is performed until the information reaches a transceiver corresponding to a container ID contained in the container control information.

In the container information control system 100 and the container information control method according to the exemplary embodiment of the present invention, the wireless access point 120 may be attached to the uppermost container having the simplest flow of the information transmission and an excellent wireless communication environment, but the wireless access point 120 does not necessarily need to be attached to the uppermost container, and may be positioned at a position at which wireless communication may be stably performed. The wireless access point 120 does not necessarily need to be attached to the container, and may be positioned at a place at which the information may be transmitted to the transceiver closest to the wireless access point 120 by using light or laser.

In a case where the wireless access point 120 is not attached to the uppermost container, the container information and the container control information may be transmitted by performing the upstream transmission, the downstream transmission, and the self transmission based on the transceiver positioned at a place closest to the wireless access point 120 among the transceivers 110.

The flowchart described in FIG. 3 only represents a fragmentary example of the transmission/reception of the information and the signal between the transceivers 110 and the wireless terminal 130, and the self transmission or the upstream transmission may be generated again after the termination of the downstream transmission, and the self transmission or the upstream transmission may also be repeatedly generated at a time interval without the downstream transmission.

The container information control system 100 and the container information control method according to the exemplary embodiment of the present invention may collect and control the container information even in a poor radio wave environment.

The container information control system 100 and the container information control method according to the exemplary embodiment of the present invention may collect and control the container information at low cost.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system for controlling information on containers loaded with at least two stages, comprising:
two or more transceivers connected to internal sensors of the containers, respectively; and
a wireless access point positioned at an uppermost container, and configured to receive the container information from the transceivers.

2. The system of claim 1, wherein the transceiver is any one of an optical transceiver or a laser transceiver.

3. The system of claim 1, wherein the container information transmitted from the transceivers to the wireless access point is contained in a message structure, which is divided into a start flag section of a specific pattern notifying a start of the information, a container ID section using coordinates of a loading space of the container, an information section containing information desired to be transmitted by each container, and a stop flag section notifying an end of the information, to be transmitted.

4. The system of claim 1, wherein each of the transceivers transmits information on a container connected to each transceiver to the wireless access point for each predetermined interval.

5. The system of claim 1, further comprising:
a wireless terminal configured to receive the container information through the wireless access point and transmit at least one signal among a signal for changing the container information, a signal for re-requesting the container information, and a signal for controlling the container through the wireless access point.

6. The system of claim 2, wherein the transceivers transmit the container information to the wireless access point by using any one of self transmission or upstream transmission.

7. The system of claim 5, wherein a signal transmitted from the wireless terminal to the wireless access point is transmitted to any one transceiver among the transceivers through downstream transmission.

8. A method of controlling information on containers loaded with at least two stages, comprising:
transmitting the container information to a wireless access point positioned at an uppermost container by using at least one of self transmission and upstream transmission by two or more transceivers connected to internal sensors of the containers, respectively.

9. The method of claim 8, wherein the transceiver is a transceiver using at least one of light and laser, and the self transmission or the upstream transmission is performed by using at least one of the light and the laser.

10. The method of claim 8, wherein the container information transmitted from the transceivers to the wireless access point is contained in a message structure, which is divided into a start flag section of a specific pattern notifying a start of the information, a container ID section using coordinates of a loading space of the container, an information section containing information desired to be transmitted by each container, and a stop flag section notifying an end of the information, to be transmitted.

11. The method of claim 8, wherein the self transmission is performed for each predetermined interval.

12. The method of claim 8, further comprising:
step (b) of transmitting at least one signal among a signal for changing the container information, a signal for re-requesting the container information, and a signal for controlling the container through the wireless access point, by the wireless terminal.

13. The method of claim 12, wherein in step (b), a signal transmitted from the wireless terminal to the wireless access point is transmitted to any one transceiver among the transceivers through downstream transmission.
